(19) United States
(12) Patent Application Publication
(10) Pub. No.: US 2006/0072319 A1
(43) Pub. Date: Apr. 6, 2006

(54) Method of using light emitting diodes for illumination sensing and using ultra-violet light sources for white light illumination

(76) Inventors: Michael E. Dziekan, Bethany, CT (US); Joseph J. Bango, New Haven, CT (US)

Correspondence Address: CONNECTICUT ANALYTICAL CORPORATION;JOSEPH J. BANGO, 696 AMITY ROAD, BETHANY, CT, 06524, US

(21) Appl. No.: 11/244,506

(22) Filed: Oct. 5, 2005

Related U.S. Application Data
(60) Provisional application No. 60/616,316, filed on Oct. 5, 2004.
(60) Provisional application No. 60/616,403, filed on Oct. 5, 2004.

(51) Int. Cl. F21V 21/00

(52) U.S. Cl. 362/249

(57) ABSTRACT

The described invention provides improvements in illumination sources for applications such as machine vision, photometry, medical imaging and microscopy. Described is the use of LED based light sources performing a dual role as narrow band light sensors. The described invention also provides a method of producing low power, “white light” illumination sources comprised of light emitting diodes and also laser diodes. The “white light” sources have improvements in illumination sources for applications such as machine vision, photometry, medical imaging and microscopy.

### CROSS REFERENCE TO RELATED APPLICATIONS

Provisional Application No. 60/616,316 was filed on 5 Oct. 2004

Provisional Application No. 60/616,403 was filed on 5 Oct. 2004

### BACKGROUND

### Field of Invention

The invention outlines a method for using ordinary Light Emitting Diodes (LED's) as both an illumination source, and as a sensing element to determine illumination characteristics. The invention also makes it possible for individual LED's to both produce and sense light of a specific and narrow wavelength. In addition, the invention outlines a method for utilizing Ultra-Violet (UV) Light Emitting Diodes (LED's) and UV Laser Diodes as white light illumination sources. The disclosed invention makes it possible for a “Natural” white light source to be realized by using a property known as fluorescence to convert invisible UV light to a lower, visible white light.

### BACKGROUND DESCRIPTION OF PRIOR ART

LED's have been used for several decades as alternative illumination sources in place of inefficient incandescent lighting. Incandescent lights are comprised of a special filament securely placed inside a glass bulb containing an ultra-high vacuum environment. The operation requires that enough power be supplied to the thin wire filament to cause it to glow to incandescence. The result is a bright illumination source at the expense of inefficient use of supplied power. Most of the wasted power is converted to heat, and cannot be utilized for lighting, only for such things as Brooders and the Easy Bake Oven. Typically the incandescent bulbs are used in homes, businesses and industries throughout the world. With the advent of the integrated circuit, and prevalence of small handheld electronic devices utilizing limited power available from tiny light weight batteries, the use of incandescent bulbs is inefficient and impractical.

LED's are small semiconductor devices that provide illumination of a specific wavelength with the application of a comparatively tiny amount of power. One would be hard pressed to examine a modern day handheld electronic device and not notice any LED's contained in it. The LED has a much greater efficiency of producing illumination verses applied power than that of an incandescent bulb. There is also little to no waste heat produced from an LED as compared to the incandescent light bulb. The only advantage an incandescent light has over the LED is that of a producing a broad spectrum of light. The incandescent light produces a broad “white” light encompassing most colors of the visible spectrum from deep red to deep violet. As any school kid knows who has ever had a basic art class, when you mix reds, greens, and blues in near equal proportions, you end up with white.

The LED on the other hand is designed to produce a very narrow wavelength of light that is virtually monochromatic. Modern day LED's have much more light output, or illumination power than LED's from only a decade ago. The current LED's have a classification known as “High Output” LED's. These LED's have a much greater light output with the same amount of applied current than older LED's. Older LED's from only a decade ago may have required 30 to 50 mA of current to produce the same light intensity as a modern day High-efficiency LED running at only 1 or 2 mA (mA or milli-Amps are equal to 10⁻³ Amps). The color spectrum available for contemporary LED's ranges from Far-Infrared, through the visible spectrum, and up into the Ultra-Violet portion.

By utilizing the UV LED's as an illumination source in conjunction with a phosphor coating, the invisible UV radiation will be converted to a longer wavelength “white light” source. By clustering several of these modified LED's, a practical alternative to the incandescent light bulb can be realized. If the same principle is applied to newer UV laser diodes, then a very intense “white light” source can be realized. If a suitable diffusing lens or material is placed in front of a plurality of modified UV laser diodes, then a soft, natural, highly efficient “white light” source can be realized to replace the inefficient, power hungry incandescent light.

It has long been established that LED's are highly efficient sources of illumination, but what is not as widely known is that the same LED can be used in a reciprocal manner, they can also sense light! Forrest M. Mims III made the discovery of this “dual use” of LED's as light sensors over a decade ago. Forrest wrote a paper for Applied Optics magazine in 1992, entitled “Sun Photometer with Light-Emitting Diodes as Spectrally Selective Detectors”. In this paper Forrest describes how to use LED's in a reciprocal role as a narrow band light sensor. The LED functions as a wavelength specific light detector. In traditional Sun photometers, a light detector such as a wide optical bandwidth Photo-Diode is used in conjunction with a narrow band optical filter to determine the intensity of a specific wavelength of light. In fact Forrest M. Mims III was contracted by Radio Shack® to develop a small portable multi-wavelength “Sun & Sky Monitoring Station”. The “Sun & Sky Monitoring Station” allows the user to collect very professional data related to Solar and Atmospheric conditions. All the light sensors are LED's being used in a dual role as a wavelength specific detector.

### BRIEF DESCRIPTION OF THE DRAWINGS

FIG. 1 shows a three-dimensional view of a “Ring light”. The “Ring light” is composed of a multitude of LED's (either all the same color or combinations of several wavelengths) to provide a small and efficient light source for use with a CCD camera or comparable image capture device.

FIG. 2 shows a three-dimensional view of a “Ring light” facing an illumination target. The illumination target is coated in such a way as to give specific reflectivity based on a specific wavelength of light. The illumination target is characteristic of the kind used in photography known as a “Grey Card”. The use of such a card with known reflectivity helps to balance and correct the light source.

FIG. 3 shows a three-dimensional view of a “Ring light” facing an enclosed illumination target. The enclosed illumination target is coated in such a way as to give specific reflectivity based on a specific wavelength of light. The illumination target is characteristic of the kind used in photography known as a “Grey Card”. The use of such a card with known reflectivity helps to balance and correct the light source.

FIG. 4 shows a side “cut-away” view of an enclosed illumination target and a side view of a “Ring light”. In the left most image, the ring light is shown a short distance away from the enclosed illumination. In the right most image, the “ring light” is shown connected with the enclosed illumination target. In this configuration (assuming a camera is used with the “Ring light”), most, if not all, external light is blocked. Only the light from the ring lights LED's would be of consequence.

FIG. 5 shows a schematic representation of a series of images that outline one method of performing a light level calibration. As the LED's are powered up and producing illumination, single LED's could be removed from their power source (switched off) and operated as a light sensor. The single LED (or multiple LED's) that is used as a sensing device could be rapidly switched throughout the ring in a sequential, random, or pseudo-random order.

FIG. 6 shows a schematic representation of a circuit used to provide power for individual LED illumination, as well as the ability to switch to a sensing mode, whereby the LED would provide a proportional output voltage based on incident light.

FIG. 7 shows a three-dimensional view of a common gas-filled fluorescent light bulb. The fluorescent bulb is filled with a rarified gas, most commonly mercury vapor, and the inside portion of the clear glass coated with a phosphor coating.

FIG. 8 shows a three-dimensional view of three LED's in varying stages of operation. A UV LED emitting UV radiation, application of a phosphor coating, and operation of a UV LED with a phosphor coating producing visible “white light”.

FIG. 9 shows a three-dimensional view of three laser diodes in varying stages of operation. A UV laser diode emitting coherent UV radiation, application of a phosphor coated plate and operation of a UV laser diode with a phosphor coated plate producing intense, semi-coherent visible “white light”.

### DETAILED DESCRIPTION OF THE INVENTION

The use of ordinary LED's to produce light has long been established, and is widely known. The use of these same light producing LED's as light sensors is not as widely known. In the early 1990's, Forrest M. Mims III was experimenting with utilizing LED's as narrow wavelength detectors. When studying atmospheric haze, a wide band photodiode is used in conjunction with a narrow band optical filter. This allows the user to analyze a single, or a relatively small number of frequencies. A single frequency of light is a valuable analysis tool when measuring haze in the atmosphere. The use of LED's as selective narrow band wavelength sensors has the advantage of greater stability over the life of the device, and lower cost, since the LED does not require a narrow band filter—it IS a narrow band filter and detector.

In contemporary illumination sources for machine vision, medical imaging, digital photography, etc., an incandescent light source is commonly used, or a ring of closely spaced LED's is used. These are somewhat expensive, and can be difficult to produce to get very uniform results. Many machine vision system manufacturers use “Ring lights” composed of many individual LED's with high current pulses applied briefly to each individual LED. This allows for a much greater output of light, while not degrading the useful life of the LED in the process. If the large current pulse were applied for a longer duration, then the LED would either be destroyed, or have its useful life would be shortened. If the pulse duration is short enough, then the LED is not damaged or stressed. The problem and complexity comes in where a microcontroller is needed to precisely control the amount of current by the use of current sensors for each individual LED, or by using a suitable light sensor such as a photodiode or phototransistor. The placement and alignment of the photosensors is critical for maximum efficiency. There is also additional circuitry to convert the incident light to a value that can be understood by the microcontroller. If the LED's themselves could be utilized as not only the illumination source, but also the light sensor, a smaller, more efficient system of regulated illumination could be realized. Since the LED's are already in place, no additional sensors are needed. If only one LED, or a small minority of LED's are used at one time for light sensing, then the resultant illumination from the rest of the LED's would provide a suitable amount of light for sensor operation. In the preferred embodiment of the described invention, an initial calibration would be done utilizing an illumination target to regulate the amount of total light provided. When designing a multiple LED light source, several problems are encountered—the LED's are usually matched to provide a uniform illumination level, each individual LED is normally bent or “adjusted” to provide a uniform point of illumination, and the power supplied to each individual LED must be closely monitored and regulated. With the new and novel described invention, the LED's themselves could control the regulation of overall illumination.

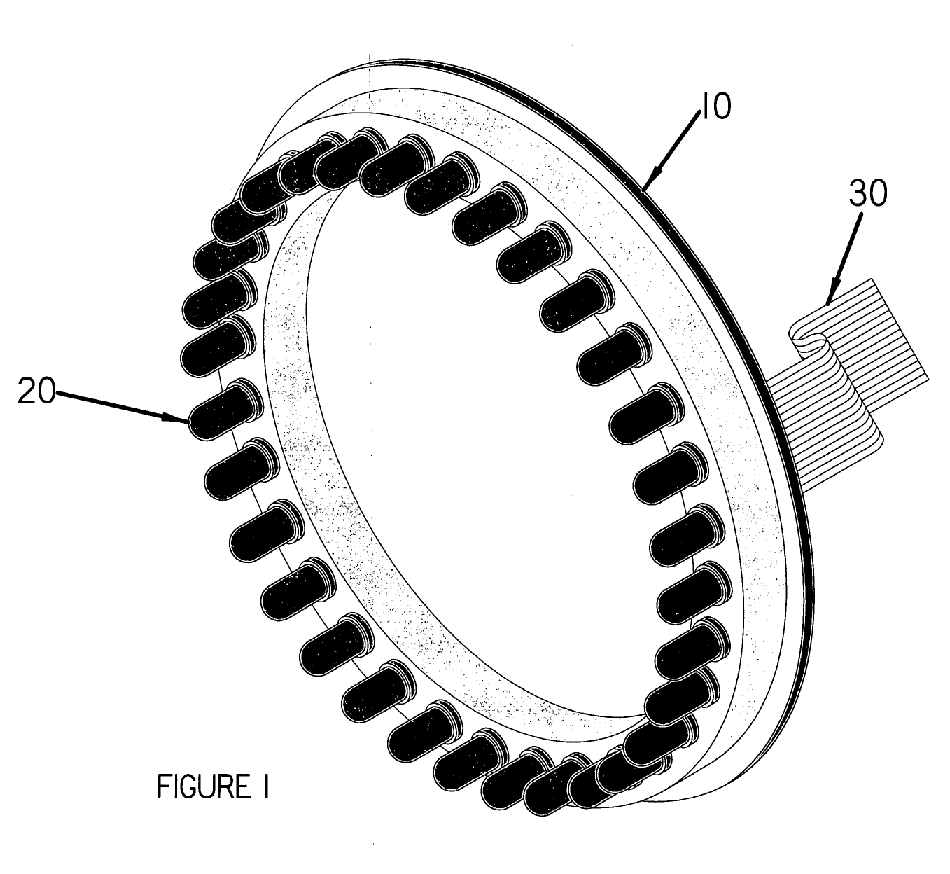

FIG. 1 shows a three-dimensional view of a typical arrangement of LED's 20 placed on a rigid circular structure 10. The power that is needed to operate each individual LED is supplied by a flexible connection 30 that has enough wires to provide each single LED 20 with a specific amount of current. If the amount of current can be precisely controlled for each individual LED 20 than the overall illumination will be much more evenly distributed resulting in a diffuse flood of light instead of a plurality of individual points.

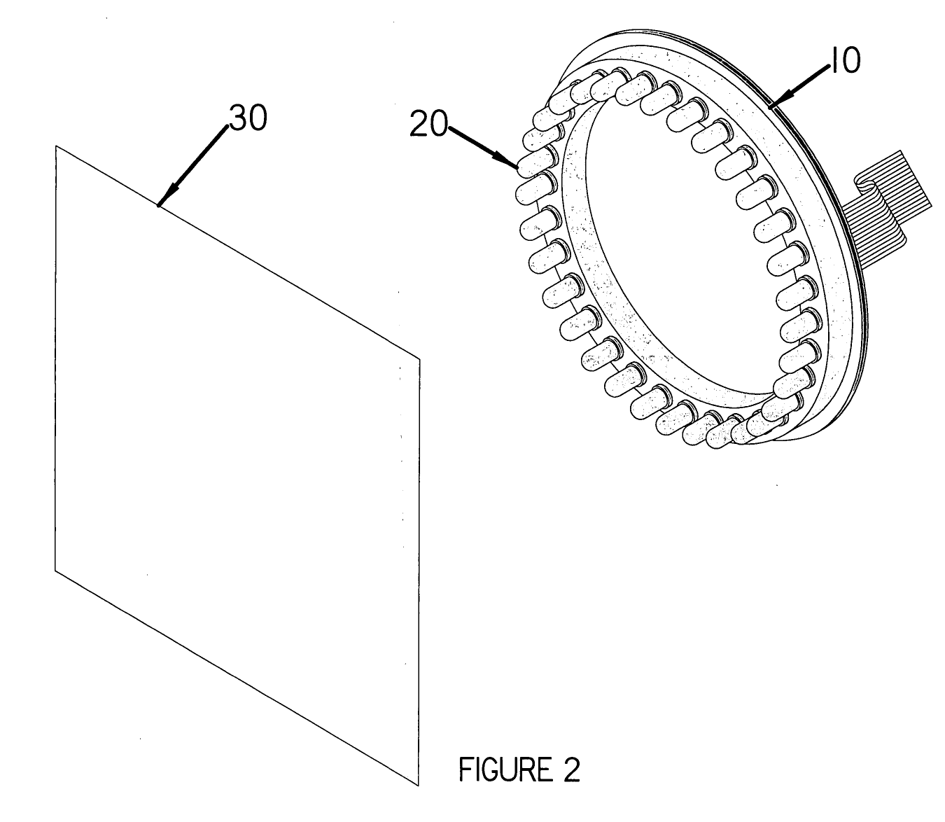

FIG. 2 shows a three-dimensional view of a ring light assembly composed of a rigid structure 10 containing a plurality of LED's 20. A card 30 coated with a reflective material very similar to a photographers “Grey card” is used as a reference to reflect a specific amount of illumination. The card 30, called a “calibration card” 30 will be used to provide calibration. When holding the “Calibration card” a known distance away from the ring light assembly 10, a specific amount of reflected light will be become incident on the individual LED's 20. By alternatively switching individual LED's 20 into a sensing mode, an algorithm could adjust each individual LED's 20 current to compensate for a lesser or greater amount brightness. By balancing the amount of brightness by adjusting the individual LED 20 current and storing this value, a microcontroller could then operate each individual LED 20 at its calibrated level.

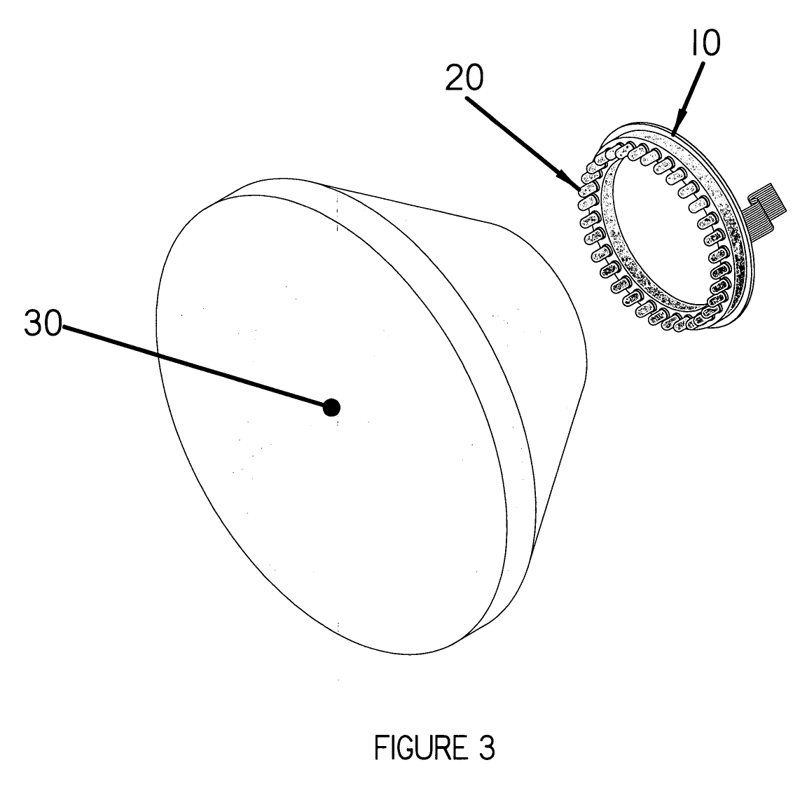

FIG. 3 shows three-dimensional view of a “Calibration card” 30 that is similar to that of FIG. 2 but with the exception of a plastic shell 30. The ring light assembly 10 is shown with the plurality of LED's 20 to provide an illumination source. When the ring light assembly 10 is placed into the opening of the enclosed “Calibration card” 30, the individual LED's 20 can be rapidly switched from an illumination source to a light sensor. In the light sensor mode, each LED 20 will measure the amount of incident light and produce a proportional voltage output that can be measured by a suitable microcontroller, analog to digital converter, or similar circuitry. This voltage value will be compared with other LED 20 sensor values to provide information to an algorithm that will adjust individual LED 20 current values to compensate for variations in intensity. The resulting current value, either pulsed or steady, will be used to ensure that the ring light assembly 10 performs at peak illumination efficiency at all times. Anytime a calibration is required, the enclosed “Calibration card” will be placed onto the ring light assembly 30 and the calibration routine will be run to determine new values of current for the individual LED's 20. The enclosed “Calibration card” 30 will ensure that a known distance is always used when performing calibration on the ring light assembly 10. The center portion of the ring light assembly 30 is shown empty, but when used, it will be filled with a lens of a suitable CCD or equivalent camera.

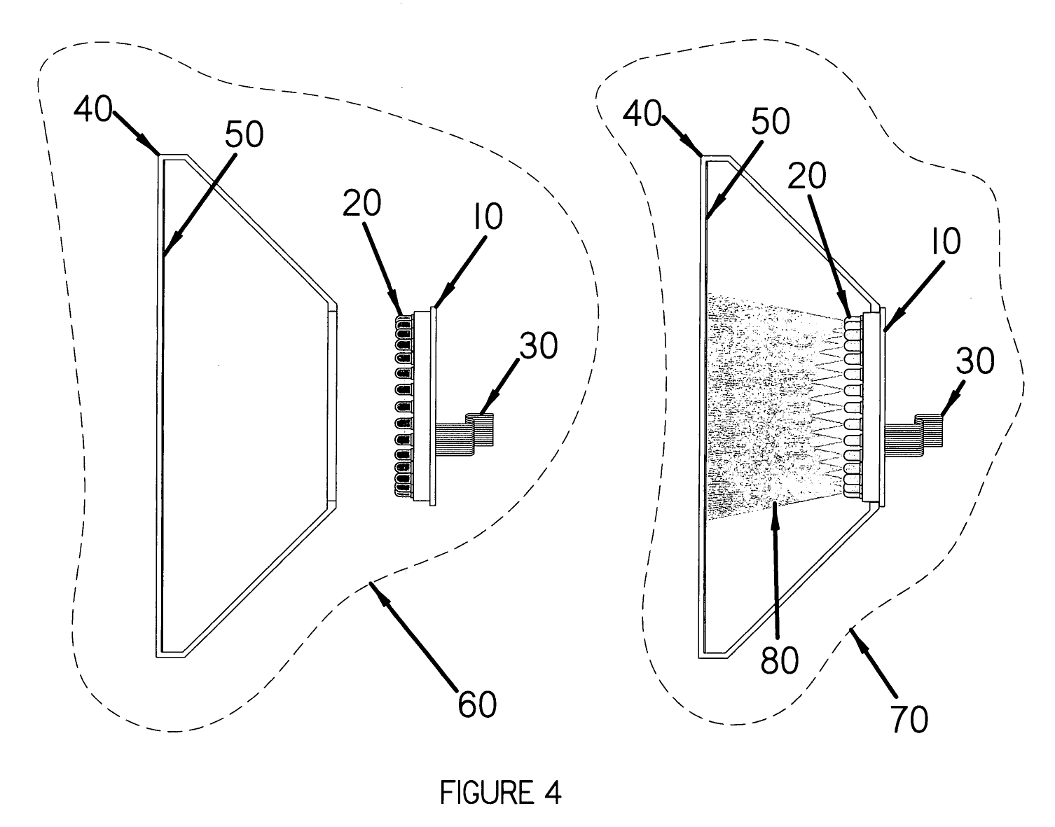

FIG. 4 shows a side view of a ring light assembly 10 and a cut away view of the enclosed “Calibration card” 40. The enclosed “Calibration card” 40 shows the interior portion including the “Grey card” material 50 that is either placed or coated inside the housing. The “Grey card” 50 material is designed to provide for a specific amount of reflection based on incident illumination at a specific wavelength. An image group indicating each separate item composed of a ring light assembly 10 and the enclosed “Calibration card” is indicated in 60. In image group 70, the individual components (ring light assembly 10 and enclosed “Calibration card” 40) are shown placed together as they would be when running a calibration. The individual LED's 20 on the ring light assembly 10 are powered up by current supplied through the flexible connection 30 and the result is illumination 80 provided by each LED 20.

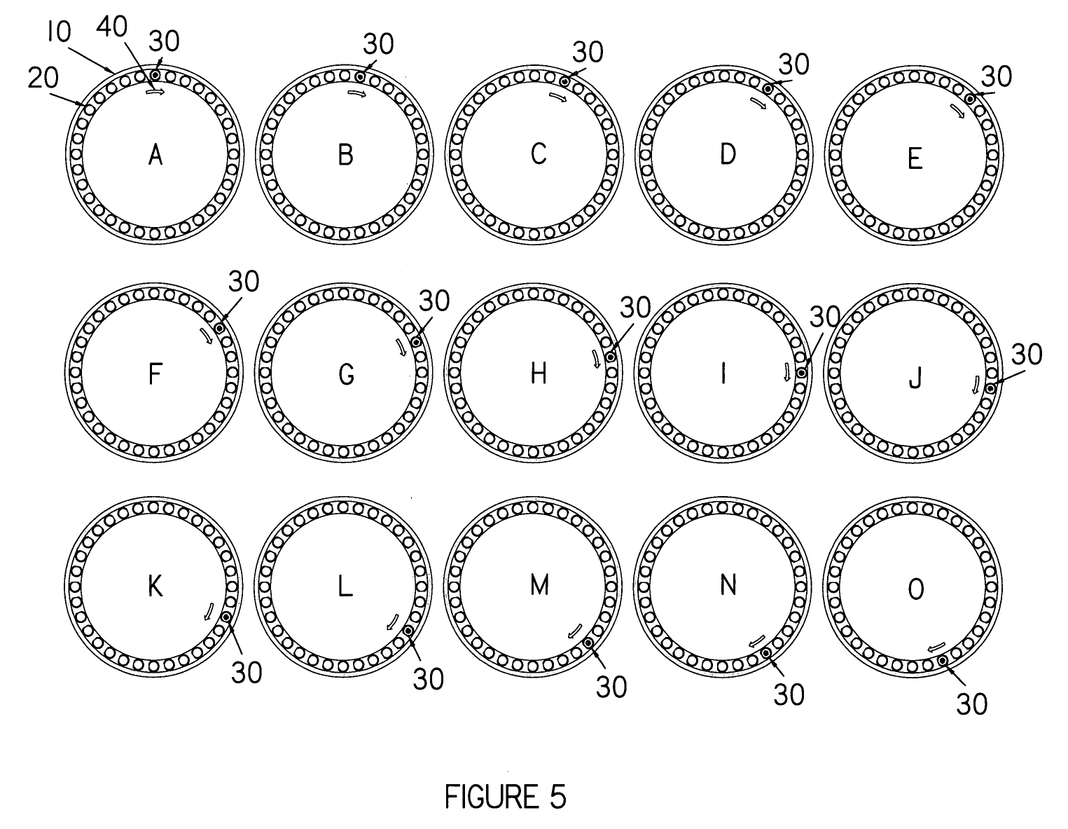

FIG. 5 shows a front view of the ring light assembly 10 indicating individual LED status as being either ON 20 (producing light) or OFF 30 (not producing light). The initial calibration routine would require one or more LED's to be switched from an ON state 20 to an OFF state 30. While the LED is in the OFF state 30, it will be used as a light sensor and provide illumination data that will be used to correct each LED to provide for an overall uniform illumination from the ring light assembly 10. The drawing shows one possible method of a light sensing calibration algorithm whereby a single LED is rapidly switched OFF 30 to serve as a light sensor and is rotated sequentially (indicated by direction arrow 40) until each LED has been used as a sensor—staring from “A” and going through to “O”, to eventually wind up at point “A” again. This process can be repeated as many times as necessary. Only “A” through “O” is shown in the limited drawing space, but it is understood that a complete cycle will be realized. Although the drawing shows a single LED switched into the sensing mode 30, a plurality of LED's could be switched into sensing mode at random or pseudo-random intervals.

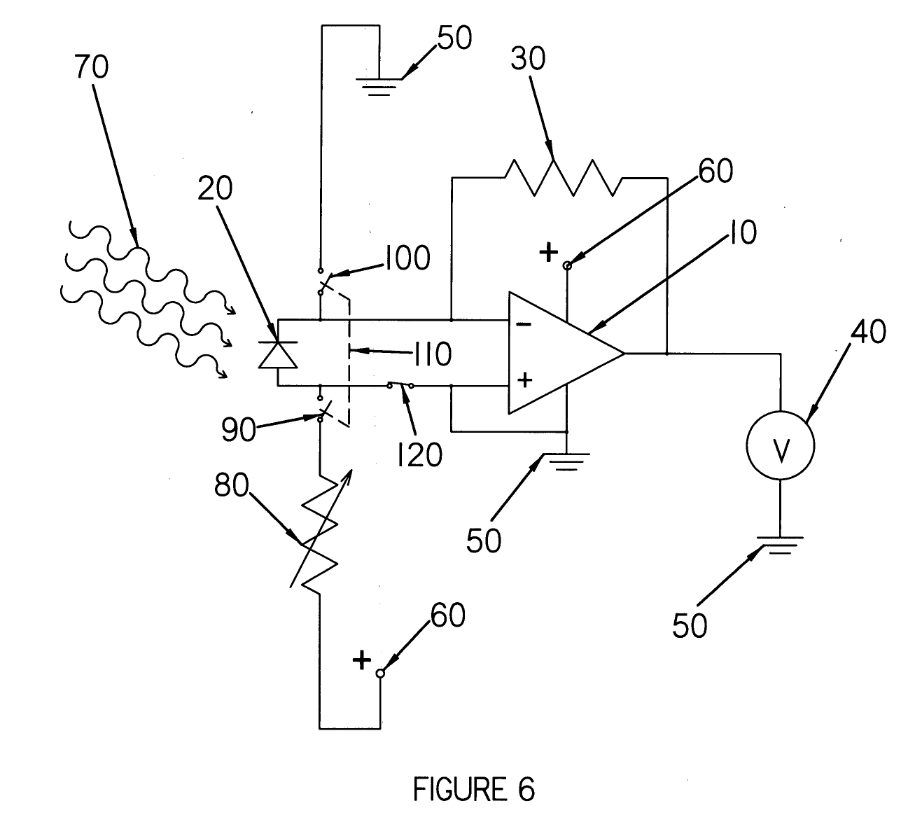

FIG. 6 shows a schematic representation of a circuit that will be used to provide power to each individual LED 20 in addition to sensing incident illumination 70 reflected back. The basic circuit consists of an operational amplifier 10 that will be used to amplify the weak signal from the LED 20, and boost it to a much greater level. The amplified voltage level will be easily measured on a voltmeter 40. The operational amplifier 10 has a specific gain level associated with it based on the value of the feedback resistor 30. As the LED 20 senses incident reflected light 70, switches 90 and 100 must be in the open position, while switch 120 must be closed. As the amount of incident light 70 increases, the LED 20 will produce a proportionally greater voltage. This voltage is too low to be read directly by an analog to digital converter, or microcontroller, so it must be amplified. The operational amplifier 10 with appropriate feedback resistor 30 will allow for a greater signal level. The circuit comprises well known schematic symbols such as a ground reference 50 and power connection 60 that anyone skilled in the art would be well familiar with. When the LED 20 is used as an illumination source, switches 90 and 100 must be closed, while switch 120 must be open. Current limiting resistor 80 is used to prevent an excessive amount of current from damaging the LED 20. Although shown as a variable resistor 80, there are several alternatives to a variable resistor, such as a transistor or a digital potentiometer. The preferred embodiment of the described invention will be composed of a transistor to regulate the amount of LED 20 current. A dashed line 110 shows the two switches 90 and 100 linked together, this normally indicates a fixed mechanical link, but it is intended to indicate that they operate simultaneously. If switch 90 opens, then simultaneously, switch 100 will open. It should be stated that switch 120 will never be closed while switches 90 and 100 are closed. If switches 90 and 100 are closed, then switch 120 will be open. If switches 90 and 100 are open, then switch 120 will be closed. An electro-mechanical switch can be used to perform these functions, but a solid state switch or transistor is preferred. The LED's 20 in all figures could be either all of a single wavelength (for example, all green) or combinations of several wavelengths (for example (Red, Blue and Green). It is preferred that an LED 20 be used to sense the same wavelength of light that it emits. If it produces green light, then it should sense the amount of green reflected light.

The ring light assembly would have an option to be synchronized to a shutter of a digital camera, so that as the digital camera shutter is open, the LED's are illuminated. The synchronization feature would also allow for the creation of color images from utilizing a Black & White camera. When a B&W, or grayscale camera is used, the object to be imaged takes a series of images—at the minimum, it would take three pictures. While utilizing a multicolor ring light, such as one composed of red, blue and green LED's, each color of LED would be illuminated as a single wavelength group. This means that the first image that is recorded by the B&W digital camera is with all the red LED's illuminated, while the green and blue LED's are off. The B&W digital camera would then image a second image of the object with only the green LED's illuminated, while the red and blue LED's are off. The last image to be imaged by the B&W digital camera is with only the blue LED's illuminated, while the red and green LED's are off. The resulting three images are combined together on a suitable interfaced computer to render a composite color image of the object. This method would allow for an inexpensive B&W digital camera to image objects in color. The time between images of different color should be kept as short as practical, so as to keep complete image registration between multiple images.

The use of incandescent light bulbs for lighting is nothing new; using clusters or groups of solid state LED's is a relatively new concept. A low power rival to that of incandescent light bulbs is the fluorescent light bulb. Fluorescent light bulbs typically are comprised of a long hollow glass tube that can be either straight, curved, or spiraled, and have been evacuated and filled with a small amount of mercury vapor. The fluorescent bulb has two filaments inside that both heat and provide an electric potential difference. This potential difference causes the encapsulated mercury atoms to be electrically excited. When the mercury atoms are excited, they gain energy, and become unstable. To regain their stability, a small packet or “quanta” of energy is released in the form of a photon. The photon has a characteristic wavelength of a very short length. This short wavelength is above the visible portion of the spectrum, and is in the Ultra-Violet (UV) region. If used in this form, the fluorescent light bulb would emit primarily UV light, and would be a poor source of illumination, not to mention the fact that the UV radiation would pose a health hazard to anyone in its vicinity. If a thin, even layer of phosphor is placed inside the glass tube of the fluorescent bulb; the UV radiation is converted to a longer wavelength “white light”. The UV portion of the radiation is effectively removed and a safe, bright “white light” source is produced.

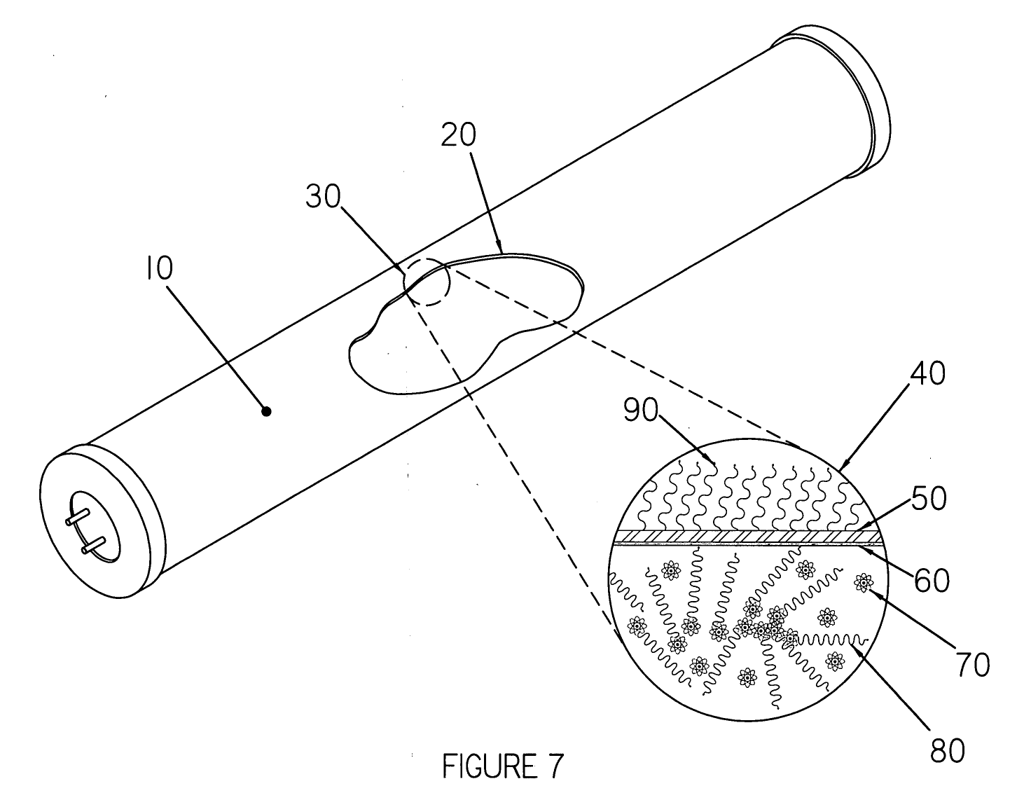

FIG. 7 shows a three-dimensional view of a typical fluorescent light bulb 10. A small section is drawn as a cutout 20 to indicate that this section will be magnified and discussed in more detail. The small dashed circle 30 is magnified to a larger section 40 to show more detail. Since the fluorescent light bulb 10 is filled with mercury vapor, when a small amount of electrical current is passed through the gas, some of the atoms of mercury 70 are placed in an energetic, excited state. When the mercury atom 70 returns to the preferential, normal ground state it releases a small packet or “quanta” of energy in the form of a photon 80 of UV, short wavelength light. The UV photon 80 travels away from the mercury atom 70 and will eventually make contact with the phosphor coating 60 on the inside wall of the glass tube 50 of the fluorescent light bulb 10. Upon encountering the phosphor coating, the UV photon 80 is absorbed by the phosphor coating 60 and re-emitted at a longer wavelength of now visible “white light” 90. Although the waves of “white light” 90 are shown in step with relation to each other, this is not the case. The resulting “white light” 90 is non-coherent.

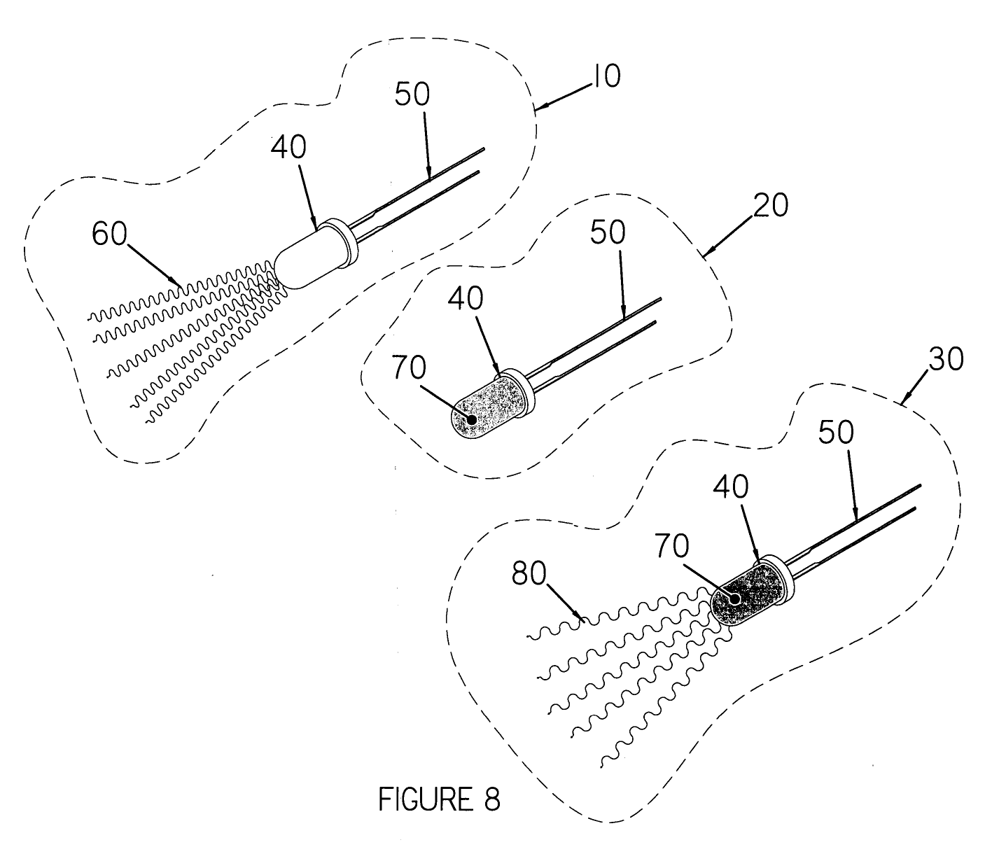

FIG. 8 shows a three-dimensional view of three images of a UV LED. The first image 10 shows the UV LED's main body 40 portion along with the power connections 50 that will be connected to a source of power to operate the LED. As a source of power is applied to the LED by connecting power to the LED leads 50, the LED will emit short wavelength, UV photons 60. The second image 20 shows how a phosphor coating 70 would be applied to the main body section of the UV LED 40. The Phosphor coating 70 on the UV LED can be applied externally or internally for prevention of scratching off of the phosphor coating 70. As shown in the third image 30, the UV LED 40 has a phosphor coating 70, and power is supplied to the LED leads 50 to cause emission of UV photons from the LED. As the UV photons strike the phosphor coating 70 of the LED 40 they are converted from a short wavelength to a longer wavelength photon 80. The short wavelength photons are outside of the visible spectrum, and are thus invisible, while the longer wavelength photons 80 are converted to the visible portion of the spectrum. This conversion process of the UV photons 60 by the phosphor coating 70 on the LED produces longer, lower wavelength uniform “white light”.

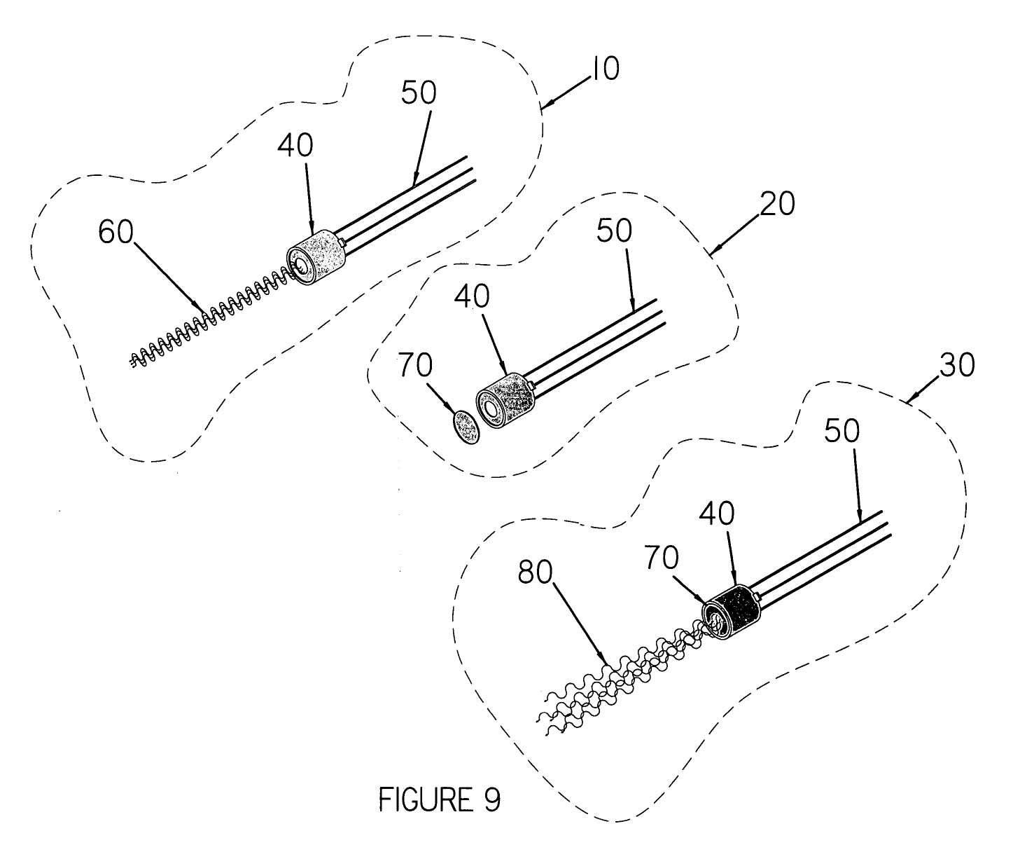

FIG. 9 shows a three-dimensional view of three images of a UV laser diode. The first image 10 shows a UV laser diodes main body 40 portion along with the power connections 50 that will be connected to a source of power to operate the laser diode. As a source of power is applied to the laser diode by connecting power to the laser diode leads 50, the UV laser diode will emit a coherent light source composed of short wavelength, UV photons 60. The second image 20 shows how a phosphor coated plate or disk 70 would be attached to the front of the main body section of the UV laser diode 40. As shown in the third image 30, the UV laser diode 40 has an attached phosphor coated disk 70, when power is supplied to the laser diode power leads 50; this causes emission of UV photons from the laser diode. As the UV photons strike the phosphor coated disk 70 of the laser diode 40 they are converted from a short wavelength to a long wavelength photon 80. The short wavelength photons 60 are outside of the visible spectrum, and are thus invisible, while the long wavelength photons 80 are converted to a visible portion of the spectrum. This conversion process of the UV photons 60 by the phosphor-coated disk 70 on the laser diode produces a longer, lower wavelength uniform “white light”. This lower wavelength converted light can now be used as a “natural” illumination source.

A diffusing lens could be added to allow for blending of the light output from several phosphor coated UV LED's or phosphor coated UV laser diodes. If a plurality of individual light sources is used, then several individual points of discrete light may be noticeable. With the addition of a diffuser, the individual light sources could be smoothly blended together to form a more well blended “white light” source.

Reference Numerals:

FIG. 1:

10 Rigid circular housing to enclose all wiring connections and hold the LED's in place.

20 Individual LED's that are used to produce and sense light.

30 Flexible wiring connection to provide power and sensing information to an external controller board.

FIG. 2:

10 Rigid circular housing to enclose all wiring connections and hold the LED's in place.

20 Individual LED's that are used to produce and sense light.

30 Grey card with a special reflective coating used to calibrate the individual LED's to provide uniform lighting.

FIG. 3:

10 Rigid circular housing to enclose all wiring connections and hold the LED's in place.

20 Individual LED's that are used to produce and sense light.

30 Plastic housing containing internal “Grey card” with a special reflective coating used to calibrate the individual LED's to provide uniform lighting.

FIG. 4:

10 Rigid circular housing to enclose all wiring connections and hold the LED's in place.

20 Individual LED's that are used to produce and sense light.

30 Flexible wiring connection to provide power and sensing information to an external controller board.

40 Plastic housing containing internal “Grey card” with a special reflective coating used to calibrate the individual LED's to provide uniform lighting.

50 “Grey card” material that is placed or coated inside the plastic housing to provide a “light tight” seal to prevent external light sources from interfering with the calibration process.

60 Assembly image of individual parts shown before they are combined together.

70 Assembly image of individual parts shown as they are combined together.

80 Light emission rays shown to indicate the pattern of light being emitted from each individual LED.

FIG. 5:

10 Rigid circular housing to enclose all wiring connections and hold the LED's in place.

20 Individual LED's that are used to produce and sense light.

30 Individual LED shown in the off state whereby it is not producing any illumination, and is being used as a light sensor.

40 Arrow indicating the direction of propagation of using each individual LED as a sensor instead of as a light source. The pattern shown here is a clockwise momentary “shutting off” of each individual LED to be used for sensing purposes to provide additional insight into overall light emission to allow for more selective control of overall light intensity. The progress is sequential starting from “A” and going through “O”. Eventually the process would return back to “A”. Although shown in an individual, sequential pattern, several LED's may be used at once, and in a random or pseudo-random order.

FIG. 6:

10 Schematic symbol of a typical Operational Amplifier (Op-Amp) used to provide amplification of the weak signal developed by the LED in response to ambient light changes.

20 Schematic symbol of a typical Light Emitting Diode (LED).

30 Schematic symbol of a typical resistor used to provide the required amount of gain for the Op-Amp so that the resulting signal will be at a usable level.

40 Schematic symbol of a typical voltmeter to indicate a voltage output when incident light of the appropriate wavelength impinges upon the LED.

50 Schematic symbol indicates a ground reference point.

60 Schematic symbol indicates a positive power point.

70 Schematic symbol indicating light rays heading towards the LED.

80 Schematic symbol of a variable resistance used to provide current limiting to the LED's to prevent damage.

90 Schematic symbol shows part of an open switch that is operationally linked to another.

100 Schematic symbol shows part of an open switch that is operationally linked to another.

110 Schematic symbol shows linkage between two switches, when one switch is activated, the other “linked” switch operates in like manor.

120 Schematic symbol shows part of a closed switch.

FIG. 7:

10 Common gas-filled fluorescent light bulb.

20 Lines indicating a cutaway section of the fluorescent light bulb.

30 Dashed circle indicating that this portion of the cutaway view of the fluorescent light bulb will be examined more closely.

40 Circle indicating magnified view of small dashed circle to show increased detail.

50 Lines indicating side-view of cutaway section of glass tube comprising the fluorescent light bulb.

60 Buildup of phosphor compounds to form a smooth layer inside the glass tube of the fluorescent light bulb.

70 Schematic representation of a mercury atom that comprises the bulk of the gas that fills the fluorescent light bulb.

80 Lines indicating emission of short wavelength, invisible UV light.

90 Lines indicating emission of long wavelength, visible wavelengths of light.

FIG. 8:

10 Dashed outline indicating a UV LED operating and producing invisible UV light.

20 Dashed outline indicating a UV LED with a phosphor coating.

30 Dashed outline indicating a UV LED with phosphor coating, operating and producing visible “white light”.

40 Main body section of LED.

50 Power leads that will be connected to a source of power for the LED.

60 Lines indicating emission of short wavelength, invisible UV light.

70 Buildup of phosphor compound used to form a smooth layer to convert the invisible UV LED radiation to a longer wavelength visible “white light”.

80 Lines indicating emission of long wavelength, visible “white light”.

FIG. 9:

10 Dashed outline indicating a UV laser diode operating and producing invisible UV light.

20 Dashed outline indicating a UV laser diode and a phosphor coated plate.

30 Dashed outline indicating a UV laser diode with phosphor coated plate, operating and producing visible “white light”.

40 Main body section of laser diode.

50 Power leads that will be connected to a source of power for the laser diode.

60 Lines indicating emission of short wavelength, coherent, invisible UV light.

70 Phosphor coated transparent plate used for the purposes of converting the invisible UV laser diode radiation to a longer wavelength visible “white light”.

80 Lines indicating emission of long wavelength, visible, semi-collimated “white light”.

We claim the following:

1. a method of utilizing a plurality of light emitting diodes as narrow band light sources

2. a method of utilizing light emitting diodes as narrow band light sensors

3. a method as in claim 1 where the light emitting diodes are strobed at regular intervals to produce uniform illumination

4. a method as in claim 1 where the light emitting diodes are strobed at irregular intervals to produce uniform illumination

5. a method as in claim 2 where the light emitting diodes are strobed at regular intervals to sense illumination intensity

6. a method as in claim 2 where the light emitting diodes are strobed at irregular intervals to sense illumination intensity

7. a method of utilizing down-converted ultraviolet light emitting diodes as broad band white light sources

8. a method of utilizing down-converted ultraviolet laser diodes as broad band white light sources

9. a method of down-conversion utilizing a phosphor coating applied internal to an ultraviolet light source

10. a method of down-conversion utilizing a phosphor coating applied external to an ultraviolet light source
